(19) United States
(12) Patent Application Publication
(10) Pub. No.: US 2021/0035174 A1
(43) Pub. Date: Feb. 4, 2021

(54) TWO-WAY TICKET EXCHANGE

(71) Applicant: Joe Edlhuber, Norcross, GA (US)

(72) Inventor: Joe Edlhuber, Norcross, GA (US)

(21) Appl. No.: 16/527,036

(22) Filed: Jul. 31, 2019

(51) Int. Cl. G06Q 30/06

(52) U.S. Cl. CPC G06Q 30/0619

(57) ABSTRACT

A two-way ticket exchange allows sellers to place an order along with their required specifications. Buyers can respond to the sellers orders with their offerings allowing sellers an option to accept their offer and buy verified and genuine tickets.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates generally to a two-way ticket exchange. More so, the present invention relates to a two-way ticket exchange that allows buyers to create a floor price of tickets that they willing to buy.

### Description of the Related Art

Reselling of tickets of various events such as a baseball event happens on through online marketplaces. These online marketplaces and ticketing exchanges allow buyers to place an order for tickets.

Currently, these online marketplaces and ticketing exchanges are biased towards sellers. For example, a seller can list available tickets of an event and buyer can choose if he wants to buy the tickets.

In light of the above mentioned drawbacks, there exists a need of a balanced and true marketplace for reselling of tickets.

### BRIEF SUMMARY OF THE INVENTION

A primary object of the disclosure is to provide a two-way ticket exchange.

Another object of the present disclosure is to allow a buyer place an order of specific tickets of an event.

Yet another object of the present disclosure is to provide buyers more options than just buying tickets listed for sale.

### DESCRIPTION OF THE DRAWINGS

Having thus described the disclosure in general terms, reference will now be made to the accompanying figure, wherein:

FIG. 1 illustrates a method for a two-way ticket exchange, in accordance with an embodiment of the present disclosure;

FIG. 2 illustrates a method for a two-way ticket exchange, in accordance with another embodiment of the present disclosure;

FIG. 3 illustrates a layout of a stadium, in accordance with an embodiment of the present disclosure;

FIG. 4 illustrates a stadium layout 400, in accordance with another embodiment of the present disclosure; and

FIG. 5 illustrates a stadium layout 500, in accordance with another embodiment of the present disclosure.

It should be noted that the accompanying figure are intended to present illustrations of exemplary embodiments of the present disclosure. This figure is not intended to limit the scope of the present disclosure. It should also be noted that accompanying figure is not necessarily drawn to scale.

### DETAILED DESCRIPTION OF THE INVENTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figure is intended and provided to illustrate embodiments of the disclosure described below and are not necessarily drawn to scale. In the drawing, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

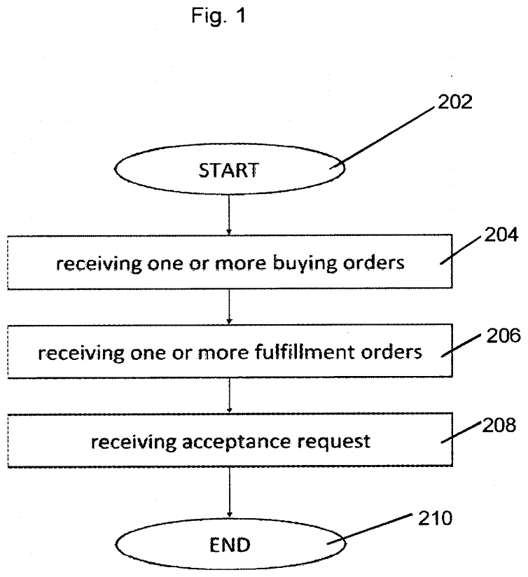

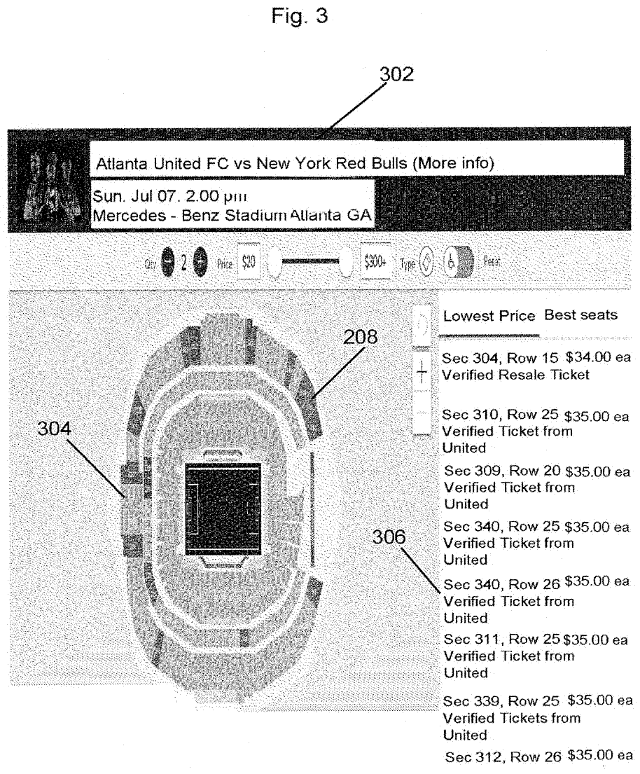

FIG. 1 illustrates 100 a method for a two-way ticket exchange, in accordance with an embodiment of the present disclosure. The method 100 initiates at step 102. At step 104, one or more buying orders for one or more events are received at the two-way ticket exchange from one or more buyers. The one or more buying orders have a first predefined specification such as two (2) tickets of a basketball game on January 01 2019 for USD 10 each in the 200 level section. The first predefined specifications are defined by the one or more buyers while placing a buying order. It will be understood to a person ordinarily skilled in the art that the first predefined specifications can be loosely defined or very specific, as per requirement of a buyer. In an embodiment of the present disclosure, the first predefined specifications can be a combination of a date of an event, ticket type, seat location, stadium type, section type and seat type. In another embodiment of the present disclosure, a buyer can see offered seats in a stadium layout. It is explained with reference to FIG. 3. It should be noted that tickets with a pre-selected time remaining can be sold by the sellers.

At step 106, one or more fulfilment orders are received at the two-way ticket exchange from one or more sellers. For example, a seller may see that a buyer has placed an order of January 01 2019 basketball game for two (2) tickets for USD 10 each in the 200 level section. The seller can agree to fulfil the above order. In an embodiment of the present disclosure, each of the one or more fulfilment orders is associated exactly one order of the one or more order from the one or more buyers. For example, for every order from a buyer, an interested seller can provide exactly one fulfilment order. In an embodiment of the present disclosure, a buyer and a seller and negotiate for a buying order. For example, if a buyer wants two (2) tickets for USD 10 each in the 200 level section and a seller can be ready to provide two (2) tickets for USD 12 each in the 200 level section, the buyer and the seller can interact with each other to agree at mutually acceptable rate of say 11 USD each.

Further, at step 108, acceptance request from the one or more buyers for the one or more fulfilment orders is received by the two-way ticket exchange. The one or more fulfilment orders are associated with the one or more buying orders. For example, if a buyer wants three tickets for USD 9 each in the 100 level section, a seller with can accept the order and agree to provide the same. When the acceptance request from the one or more buyers for the one or more fulfilment orders is received by the two-way ticket exchange, a one or more transactions is said to be completed on the two-way ticket exchange. In an embodiment of the present disclosure, the one or more transactions on the two-way ticket exchange is blockchain-verified. It will be understood to a person ordinarily skilled in the art that various technologies can be used to verify genuineness of the seller and resale tickets offered by him. In an embodiment of the present disclosure, the one or more notifications to one or more buyers and the one or more sellers at one or more stages of the one or more transactions can be sent by the two-way ticket exchange. For example, a buyer and a seller can receive notification from the two-way ticket exchange. The method 100 ends at step 110.

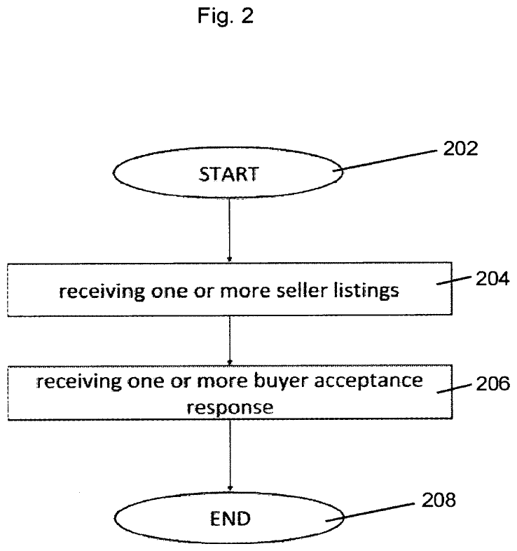

FIG. 2 illustrates a method 200 for the two-way ticket exchange, in accordance with another embodiment of the present disclosure. The method 200 initiates at step 202. At step 204, one or more seller listings associated with the one or more events are received by the two-way ticket exchange. The one or more seller listings have a second predefined specifications. The second predefined specifications are defined by the one or more seller. For example, a seller listing specifying that three tickets for USD 13 each in the 100 level section are available.

At step 206, one or more buyer acceptance response to the one or more seller listings is received by the two-way ticket exchange. Each of the one or more buyer acceptance response is associated exactly one order of the one or more seller listings. For example, a seller listing may specify that three tickets for USD 13 each in the 100 level section are available and a buyer cam accept to buy the same through a buyer acceptance response. In an embodiment of the present disclosure, a buyer can see all available seats on a stadium layout. It is explained with reference to FIG. 3. The method 200 ends at step 208.

FIG. 3 illustrates a stadium layout 300, in accordance with an embodiment of the present disclosure. The stadium layout 300 is shown to have predefined specifications 302, seating arrangement 304, available seller listing 306 and highlighted listing 308 corresponding to the available seller listing 306. It will be understood to a person ordinarily skilled in the art that the stadium layout 300 is can be representing in any format without affecting the scope of the invention.

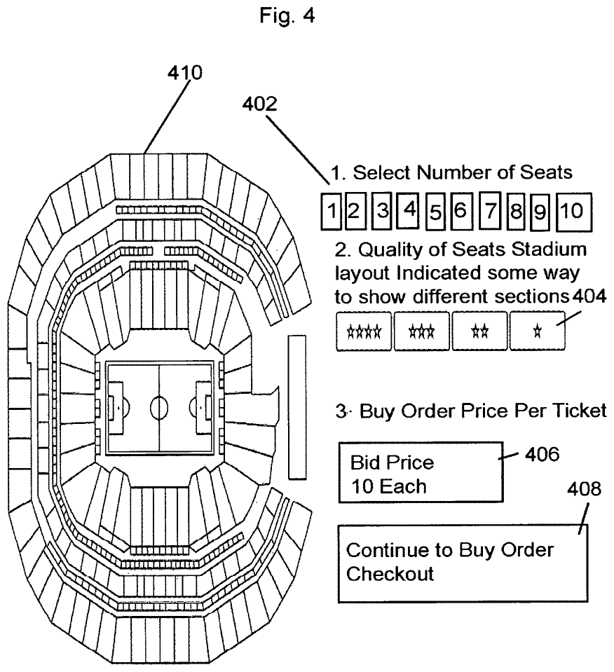

FIG. 4 illustrates a stadium layout 400, in accordance with another embodiment of the present disclosure. The stadium layout 400 is shown to have a visual seating arrangement 410, an option to select number of seats 402, an option to select quality of seats 404, an option to enter ‘buy order price per ticket’, and ‘continue to buy order checkout’ button 408. Selection of seats is shown in the subsequent FIGs. It will be understood to a person skilled in the art that stadium layout is shown are for illustration purpose only, and not to limit the disclosure.

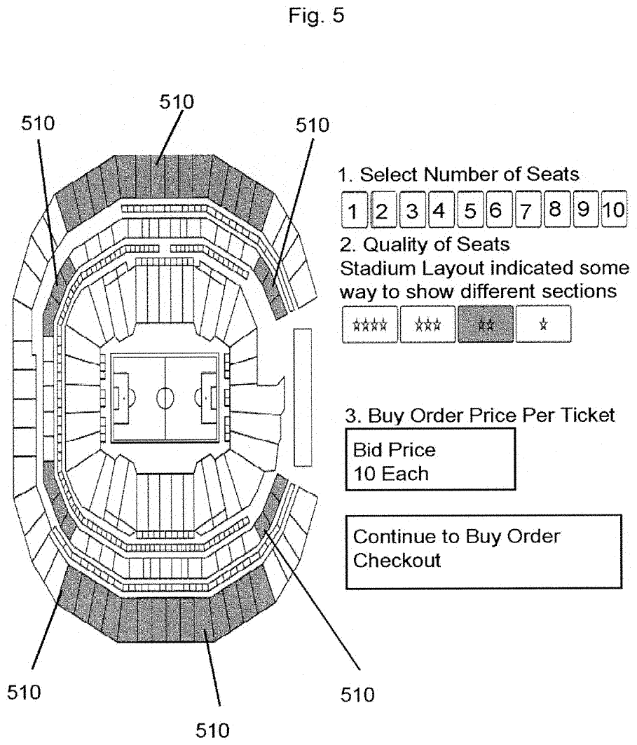

FIG. 5 illustrates a selected stadium layout 500, in accordance with another embodiment of the present disclosure. The selected stadium layout 500 shows a user has selected 2 number of seats, with two (2) star quality and is ready to pay $10 for each ticket. It is shown that when a user selects two (2) star quality seats, corresponding seats 510 get highlighted.

The two-way ticket exchange allows sellers to reach a wider market of buyers by giving buyers more options in purchasing tickets to events. The two-way ticket exchange further provide an option to buyers to create a floor price of what they're willing to pay for a ticket.

What is claimed is:

1. One or more non-transitory computer-readable media storing instructions executable by one or more processors, wherein the instructions program the one or more processors to perform acts comprising:
receiving one or more buying orders from one or more buyers, wherein the one or more buying orders have a first predefined specifications, wherein the first predefined specifications are defined by the one or more buyers, wherein the one or more buying orders are associated with one or more events, wherein the one or more buying orders are received by a two-way ticket exchange;
receiving one or more fulfilment orders from one or more sellers, wherein each of the one or more fulfilment orders is associated exactly one order of the one or more order from the one or more buyers, wherein the one or more fulfilment orders are received by the two-way ticket exchange; and
receiving acceptance request from the one or more buyers for the one or more fulfilment orders associated with the one or more buying orders, wherein the acceptance request is received by the two-way ticket exchange, whereby completing one or more transactions on the two-way ticket exchange.

2. The one or more non-transitory computer-readable media as recited in claim 1, wherein the instructions program the one or more processors to further perform acts comprising:
receiving one or more seller listings, wherein the one or more seller listings have a second predefined specifications, wherein the second predefined specifications are defined by the one or more sellers, wherein the one or more seller listings are associated with the one or more events, wherein the one or more seller listings are received by a two-way ticket exchange; and
receiving one or more buyer acceptance response to the one or more seller listings, wherein each of the one or more buyer acceptance response is associated exactly one order of the one or more seller listings from the one or more sellers, wherein the one or more buyer acceptance response are received by the two-way ticket exchange.

3. The one or more non-transitory computer-readable media as recited in claim 1, wherein the first predefined specifications of the one or more buying orders is at least one of a date of an event, ticket type, seat location, stadium type and seat type.

4. The one or more non-transitory computer-readable media as recited in claim 1, wherein the one or more transactions on the two-way ticket exchange is blockchain-verified.

5. The one or more non-transitory computer-readable media as recited in claim 1, wherein the one or more fulfilment orders associated with the one or more buying orders are tickets to an event, wherein the tickets are verified.

6. The one or more non-transitory computer-readable media as recited in claim 1, wherein the two-way ticket exchange is a resale ticket selling platform.

7. The one or more non-transitory computer-readable media as recited in claim 1, wherein the instructions program the one or more processors to further perform acts comprising sending one or more notifications to one or more buyers and the one or more sellers at one or more stages of the one or more transactions.

8. A method practiced at a two-way ticket exchange, the method comprising:
receiving one or more buying orders from one or more buyers, wherein the one or more buying orders have a first predefined specifications, wherein the first predefined specifications are defined by the one or more buyers, wherein the one or more buying orders are associated with one or more events, wherein the one or more buying orders are received by a two-way ticket exchange;
receiving one or more fulfilment orders from one or more sellers, wherein each of the one or more fulfilment orders is associated exactly one order of the one or more order from the one or more buyers, wherein the one or more fulfilment orders are received by the two-way ticket exchange; and
receiving acceptance request from the one or more buyers for the one or more fulfilment orders associated with the one or more buying orders, wherein the acceptance request is received by the two-way ticket exchange, whereby completing one or more transactions on the two-way ticket exchange.

9. The method practiced at the two-way ticket exchange as recited in claim 1 further comprising:
receiving one or more seller listings, wherein the one or more seller listings have a second predefined specifications, wherein the second predefined specifications are defined by the one or more sellers, wherein the one or more seller listings are associated with the one or more events, wherein the one or more seller listings are received by a two-way ticket exchange; and
receiving one or more buyer acceptance response to the one or more seller listings, wherein each of the one or more buyer acceptance response is associated exactly one order of the one or more seller listings from the one or more sellers, wherein the one or more buyer acceptance response are received by the two-way ticket exchange.

10. The method practiced at the two-way ticket exchange as recited in claim 1, wherein the first predefined specifications of the one or more buying orders is at least one of a date of an event, ticket type, seat location, stadium type and seat type.

11. The method practiced at the two-way ticket exchange as recited in claim 1, wherein the one or more transactions on the two-way ticket exchange is blockchain-verified.

12. The method practiced at the two-way ticket exchange as recited in claim 1, wherein the one or more fulfilment orders associated with the one or more buying orders are tickets to an event, wherein the tickets are verified.

13. The method practiced at the two-way ticket exchange as recited in claim 1, wherein the two-way ticket exchange is a resale ticket selling platform.

14. The method practiced at the two-way ticket exchange as recited in claim 1, wherein the instructions program the one or more processors to further perform acts comprising sending one or more notifications to one or more buyers and the one or more sellers at one or more stages of the one or more transactions.
